(19) United States
(12) Patent Application Publication
(10) Pub. No.: US 2018/0091974 A1
(43) Pub. Date: Mar. 29, 2018

(54) Network Operations Center With User Authorization Interface

(71) Applicants: Lee Dickens, Norcross, GA (US); Ronald Peterson, Johns Creek, GA (US); James Tubo, Sandy Springs, GA (US)

(72) Inventors: Lee Dickens, Norcross, GA (US); Ronald Peterson, Johns Creek, GA (US); James Tubo, Sandy Springs, GA (US)

(73) Assignee: Hospitality Core Services, LLC, Norcross, GA (US)

(21) Appl. No.: 15/278,355

(22) Filed: Sep. 28, 2016

(51) Int. Cl. H04W 12/06; H04L 29/06; G06Q 50/12

(52) U.S. Cl. CPC H04W 12/06; H04L 63/101; G06Q 50/12; H04L 63/083; H04L 63/0876

(57) ABSTRACT

A network operations center (NOC) that displays computer identification information obtained from user devices that are connected to, but not authorized to use, the computer network. The computer identification information typically includes a computer name, IP address, MAC address, location, or failed registration attempt time. The NOC receives full or partial computer identification information obtained during a trouble call and identifies the corresponding computer identification information for pre-authorization user devices connected to the network. This allows the network administrator to identify the user's device on the network and authorize the user's device to receive Internet access without having to receive and enter complete computer identification information, such as the full MAC address for the device. As a result, the trouble calls are resolved quickly with a minimal amount of information from the user.

### TECHNICAL FIELD

The present invention relates to computer network management and, more particularly, to network operations center including a user interface or “dashboard” that facilitates user authorization. The network operations center may support user authorization for temporary guest Internet access at a hotel, airport, restaurant or similar hotspot.

### BACKGROUND OF THE INVENTION

Many establishments, such as hotels, airports, restaurants and other hotspots provide guests with temporary Internet access. These systems often utilize a network operations center (NOC) usually associated with a call center that allows an administrator to monitor and control network operations at multiple locations from a central network control location. A single NOC may administer the networks of hundreds or even thousands of properties, each providing network access to scores, hundreds or thousands of end user devices. While centralization of network administration produces a range of benefits, handling thousands of user devices at a single location can be challenging. Inevitably, some percentage of users will have difficulty connecting to the network. A human technician referred to generally as the “administrator” is responsible for resolving these connection difficulties, for example through telephone or online support sessions. By the time a user who has experienced difficulty attempting to obtain network access reaches the administrator with a “trouble call” seeking help, the user may already be frustrated.

Resolving these trouble calls in an efficient and expedited manner is an important aspect of high quality customer service. Troubleshooting a user's connection problem often begins with the NOC administrator attempting to identify the user's device among the thousands of devices connected to a large number of local networks supported by the NOC. This “needle in a haystack” search typically involves asking the user to provide a unique identifier associated with the user's device, such as the machine address (MAC address) assigned the user's device. The MAC address, which is typically expressed as a ten-digit number separated by colons, is often displayed in tiny print on a label attached to the device. For some types of device, such as smartphones, the label may be located under the device's battery. Reading the MAC address in this circumstance requires depowering the device to read the label, which may require termination of a support session being conducted with the device and disconnect them from the network they are trying to log onto. Alternatively, the MAC address may often be obtained through a lookup using a specific set of commands entered into the user's device. But the specific lookup commands vary among different types of devices and operating systems making it difficult for the administrator to readily recall or ascertain how to locate the MAC addresses on a myriad of different types of devices. Moreover, reading the MAC address from the device and entering it into the administrator's system is prone to data reading and entry errors. In many case, the connection issue can be quickly resolved once the user's device has been located on the network. Merely obtaining and entering the user's MAC address into the administrator's system may therefore be the most challenging part of the troubleshooting process.

A need therefore exists for improved mechanisms for handling trouble calls at a network operations center. More particularly, a need exists for and an improved technique for quickly and accurately identifying user devices on a network system supporting a large number of user devices.

### SUMMARY OF THE INVENTION

The present disclosure meets the needs described above in a system for computer network administration, a network operations center, a method and a computer storage medium containing instructions for operating a network operations center. A number of access points each connect a number of user devices to a computer network. A number of gateways each connect a number of the access points to the network. Each gateway provides interrogation access to computer identification information associated with the user devices connected to the gateway or the access points connected to the gateway.

The network operations center detects computer identification information associated with user devices connected to the computer network and receives computer identification information associated with user devices authorized to use the computer network. The network operations center also determines computer identification information associated with pre-authorization user devices connected to, but not authorized to use, the computer network. A user-interface selection panel shows the computer identification information associated with the pre-authorization user devices. A selection command entered through the user-interface selection panel identifies a selected pre-authorization user device for authorization to use the network. The network operations center then authorizes the selected pre-authorization user device to use the network in response to the selection command.

In an illustrative embodiment, the network operations center may receive a user connection support request from a requesting user associated with a selected pre-authorization user device. The network operations center may also receive support request computer identification information from the requesting user associated with the selected pre-authorization user device. The network operation center compares the support request computer identification information to the computer identification information associated with the pre-authorization user devices. The network operations center then identifies a detected computer identification information record associated with the selected pre-authorization user device based on the support request user identification information. For example, the support request computer identification information may include a full or partial computer name, IP address, MAC address, location or failed logon attempt time associated with the selected pre-authorization user device.

The network operations center may also receive authorization information from the requesting user, which it utilizes to authorize the pre-authorization user device to use the network. For example, the authorization information may include a room number and guest name associated with a hotel guest registration, payment data, a user name and password associated with the pre-authorization user device, or a user name and password associated with the registering user.

In view of the foregoing, it will be appreciated that the present disclosure provides an improved network operations center for administering access to a computer network. The specific systems and techniques for accomplishing the advantages described above will become apparent from the following detailed description of the embodiments and the appended drawings and claims.

### BRIEF DESCRIPTION OF THE DRAWINGS

FIG. 1 is a conceptual illustration of a computer network access management system in accordance with an embodiment of the invention.

FIG. 2 is a conceptual illustration of a computer network access management system in accordance with an alternate embodiment of the invention.

FIG. 3 is a conceptual illustration of a user interface for a network operations center in accordance with an embodiment of the invention.

FIG. 4 is a conceptual illustration of an additional user interface for a network operations center in accordance with an embodiment of the invention.

FIG. 5 is a logic flow diagram for operating for a network operations center in accordance with an embodiment of the invention.

FIG. 6 is an addition logic flow diagram for operating for the network operations center in accordance with an embodiment of the invention.

### DETAILED DESCRIPTION OF ILLUSTRATIVE EMBODIMENTS

The present disclosure may be implemented as part of a network operations center (NOC) deployed at a hotel, airport, hotspot or similar type of computer network access system. A guest desiring network access typically registers for use through an authentication process. In many cases, registration is required the first time the guest accesses the network, while subsequent access does not require re-registration each time the user accesses the network. Registration may be limited to a certain period of time, such as the period of a hotel guest's stay, and may require payment for basic or upgraded service. Even if payment is not required, the guest may be required to register to agree to “click wrap” terms and view the provider's portal page.

Registration typically involves a number of steps that take place between the guest's computer and the network management system. These steps generally include connection of guest computer to a wireless access point or wired port using a service set identifier (SSID) entered into the wireless access point or wired port. A dynamic host configuration protocol (DHCP) server then assigns a temporary internet protocol (IP) address to the guest computer, which allows the guest computer to connect to an Internet gateway. When a browser running on the guest's computer attempts to reach an Internet site, the Internet gateway redirects the user's browser to an authentication server that causes the browser to load a login or similar authentication page. The guest then enters the required information into the authentication page to register for network access, which may require authorizing a payment and agreeing to terms and conditions.

The network management system receives and may record certain information throughout this process, such as the computer name recorded in the guest computer's operating system, the permanent machine (MAC) address assigned to the guest computer, and the temporary IP address assigned to the guest computer by the DHCP server. This network management system typically utilizes at least the MAC address to identify and authorize the guest computer during the registration process. Authorization typically includes entering the MAC address assigned to the user's computer onto a list of authorized users along with other service parameters, such as an authorized period of time and service level. For example, the authorized time period may correspond to a user's stay as a registered guest at a hotel or a time for which they have purchased service. The service level may correspond to a bandwidth parameter that the user has paid for or otherwise qualifies to receive. While the MAC address assigned to the user's computer remains on list of authorized users, registration is not required during subsequent network access sessions.

To facilitate authorization of user devices that have encountered access problems, the NOC displays computer identification information obtained from “pre-authorization” user devices, which are user devices that are connected to, but not authorized to use, the computer network. The computer identification information typically includes a computer name, IP address, MAC address, location, or failed registration attempt time. This is a great advantage because the list of pre-authorization user devices is much smaller than the full list of connected or authorized devices, which typically numbers in the thousands of devices. The network operations center receives full or partial computer identification information obtained during a trouble call and identifies the corresponding computer identification information within the pre-authorization user devices list. In addition, the administrator is not limited to receiving the MAC address, but may locate the pre-authentication device on the network using a full or partial entry of any item of the computer identification information as alternatives to the MAC address. Alternate computer identification information may include, for example, the computer name, the IP address, the location where the user is attempting to register, and the time of a failed registration attempt. This allows the network administrator to identify the user's device on the network and then authorize the user's device to receive Internet access without having to receive and enter complete computer identification information, such as the full MAC address for the device. As a result, the trouble calls are resolved quickly with a minimal amount of information from the user.

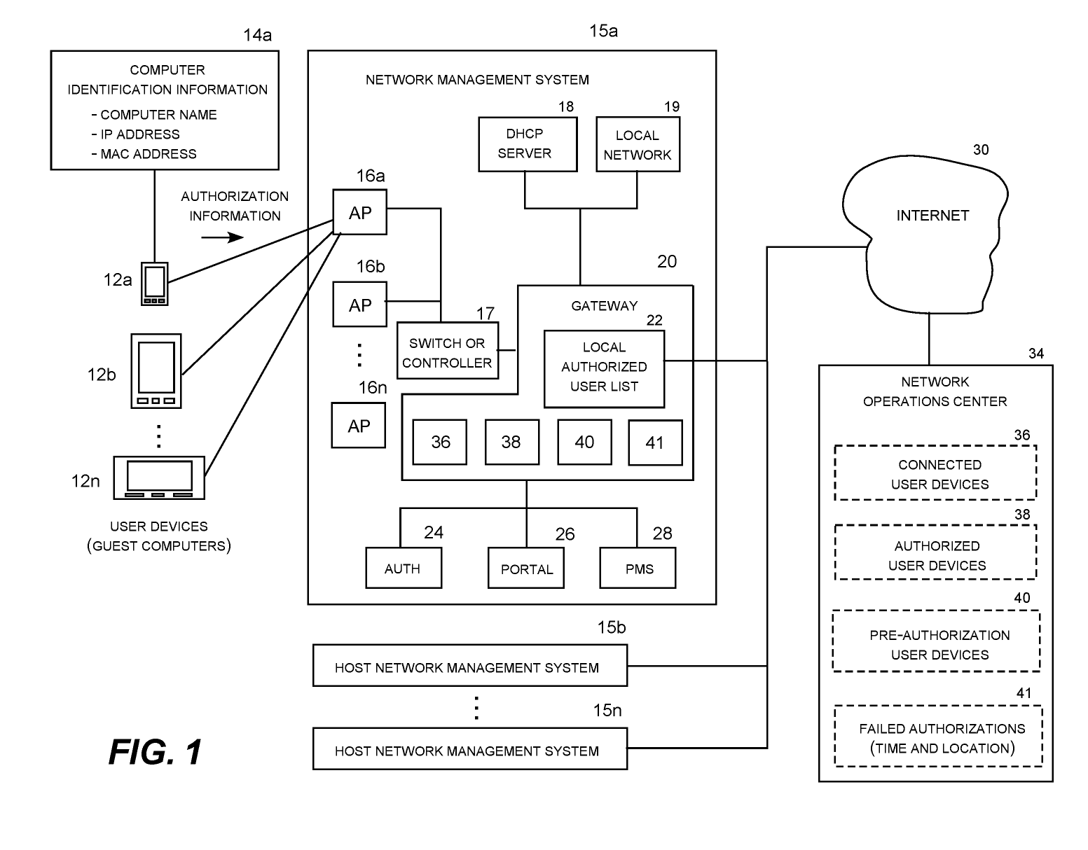

FIG. 1 is a conceptual illustration of a computer network system 10 in accordance with an embodiment of the invention. The system is configured to provide computer network access services, such as Internet access, to a number of user devices represented by the user devices 12a-n. Embodiments of the system 10 may be configured to provide temporary Internet to guest computers, such as guests at hotels, airports, restaurants, multiple-unit dwelling complexes and other hotspots providing temporary network access. For example, the guest computers may be portable laptop computers, tablets, smartphones, personal digital assistants, pagers and other devices configured to connect to computer networks. Each user device has a variety of computer identification information represented by the computer identification information 14a assigned to the user device 12a. Under currently prevailing protocols, the computer identification information includes at least (a) a permanent machine or MAC address assigned to the device at the time of manufacture; (b) a computer name assigned by the user at the time of initial configuration; and (c) an IP address assigned by a network management system for communicating on the network. By convention, the MAC address is a permanent identifier assigned to a particular piece of hardware while the IP address may be a temporary network address assigned by a Dynamic Host Control Protocol (DHCP) when the user device connects to the network managed by the DHCP server. While there may be other types of computer identification information assigned to the user device (e.g., workgroup name, home network name, etc.) the MAC address, computer name and IP address are sufficient for describing illustrative embodiments of the invention.

A number of network management systems 15a-n each provide network access service to a large number of user devices. In particular, each network management system may provide access to the Internet 30 for guests at a hotel, airport, restaurant or other hotspot. In the example shown in FIG. 1, the illustrative user devices 12a-n are connected to the illustrative network management system 15a by way of an illustrative access point 16a. Additional access points 16b-n each connect a number of user devices to the network management system 15a typically via a switch or wireless controller 17. Similarly, additional network management systems 15b-n each include a number of access points that each connect a number of user devices to the Internet 30.

The illustrative network management system 15a includes the access points 16a-n, switch or wireless controller 17 along with a DHCP server 18, and local network or LAN 19, and a gateway 20 having or communicating with a local authorized user list 22. In this example, guest users are authorized to use the Internet 30 by an authorization server 24, which requires users to view one or more pages on a host portal 26 when the initially logging on for network service. For example, the authorization server 24 may keep track of authorization requirements and status for various users, while the host portal 26 provides information about the host, requires to user to agree to access term, and may require payment for network service. Many registration options are possible. For example, club members and premium credit card holders may receive free Internet access, while others may be required to pay a fee for access. Registered hotel guest may be entitled to charge the access fee to their rooms, while others may have to enter a debit or credit payment authorization. Network access fees charged to a guest room may be included in the guest's “folio” billed through a Property Management System (PMS) 28. The invention is not limited to any particular registration or payment procedure.

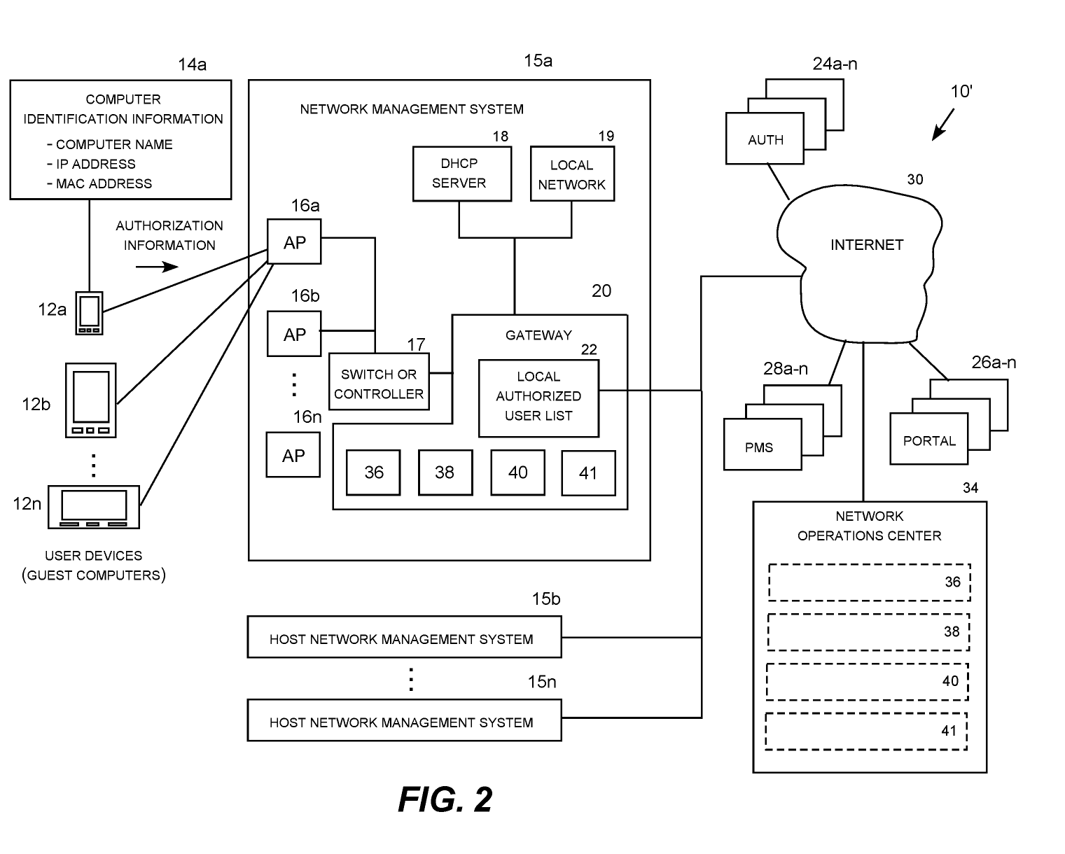

FIG. 2 is a conceptual illustration of an alternative computer network system 10′ generally referred to as a “cloud” embodiment. In this alternative, the authorization servers 24a-n, portals 26a-n and Property Management Systems 28a-n are network devices located on the Internet 30. The illustrated computer network systems 10 and 10′ are representative environments in which embodiments of the invention may be deployed. Those skilled in the art will recognize that many other network layouts may be implemented, and many other types of devices may be included in each network management system 15a-n, commonly referred to switches, controllers, routers, concentrators, and so forth. Devices commonly referred to as switches, routers, firewalls, servers and other designations associated with local networks that directly or indirectly control user device access to wide area networks, such as the Internet, are included within the meaning of the term “gateway” in this disclosure. The invention is not limited to any particular gateway configuration or network layout. The following description may refer only to the elements enumerated on FIG. 1 for descriptive convenience.

A centralized network operations center (NOC) 34 provides administration services to the network management systems 15a-n. A typical NOC may support hundreds or thousands of properties with network management systems, which each provide computer access to hundreds or thousands of user devices. A network administrator at the NOC provides a variety of services to the network management systems 15a-n, such as system testing, activation, software updates, diagnostics monitoring, statistical aggregation and analysis, troubleshooting, and so forth. Resolving user connection problems is a challenging aspect of NOC operations due to the sheer number of supported user devices. A wide range of different type of user devices using different operating systems, browsers, and specialized software may attempt to connect to the various network management systems. While the gateways will be able to automatically connect the great majority of these user devices, some percentage of user devices will encounter connection problems. With the range of devices and associated software constantly changing with the pace of technology, some level of connection difficulties can be expected to persist. To provide just a few examples, a user device may be unable to connect due to a network setting error, DHCP error, an addressing conflict, browser incompatibility, a browser proxy interfering with loading of the logon page, long running script or other timeout problem, and so forth.

Authorization failures and network setting error (e.g., misconfiguration of TCP/IP parameters, failure to have DHCP selected for network configuration, hard coded DNS server not supported by DHCP, incompatible ports or other encryption settings, etc.) are among the most frequent types of support calls that reach a typical NOC administrator. An authorization error might occur for the representative user device 12a even though the user device is able to connect to the AP 16a, which is able to communicate with the gateway 20. The user device 12a may be nevertheless unable to register with the authorization server 24 so that the user device is included in the local authorized user list 22. This can happen when the user device 12a is unable to complete the registration process for any reason. An authorization failure may be caused by a range of difficulties that can arise in the interaction between the user device 12a and the authorization server 24, the portal page 26 or the PMS 28.

To provide a few examples, the browser running on the user device 12a might block a portal page, or the browser might be unable to process a script running on the portal page. The user device might be programmed to automatically direct the browser to a different page. The user device may be unable to receive or process the registration browser pages. As another example, a registration failure may occur if the user is unable or unwilling to enter the required registration information, for example because the user cannot locate certain information or believes they have access privileges not reflected by the gateway. Many other types of connect problems may arise and the invention is not limited to any particular type of connection problem.

Because the MAC address is a unique identifier permanently assigned to a particular hardware device, the local authorized user list 22 typically relies on a list of MAC addresses. As a result, troubleshooting a network connection problem for a pre-authorization user device often involves obtaining the MAC address for the device from the user. Each MAC address is ordinarily formatted as six two-digit codes separated by colons (e.g. 12:34:56:78:90:12). Most users are not aware of the MAC address assigned to their device, which is often located in tiny print on a label attached to the device. For some types of device, such as smartphones, the label may be located under the device's battery, which requires depowering the device to read the label. Alternatively, the MAC address may often be obtained through a lookup using a specific set of commands entered into the user's device. But the specific lookup commands vary among different types of devices and operating systems making it difficult for the administrator to readily recall or ascertain how to locate the MAC addresses on a myriad of different types of devices. Moreover, reading the MAC address from the device and entering it into the administrator's system is prone to data reading and entry errors. In many case, the connection issue can be quickly resolved once the user's device has been located on the network. Merely obtaining and entering the user's MAC address may therefore be the most challenging part of the troubleshooting process.

FIG. 1 illustrates a solution to this problem provided though information automatically obtained and displayed by the NOC 34 to assist the administrator in identifying and registering a user for network access. A user device that has connected to a supported gateway but has not yet registered is referred to as a “pre-authorization” user device to facilitate the description. Directing the operator of the user device 12a to connect to the access point 16a is a relatively familiar process requiring selection of the service set identifier (SSID) for the correct wireless network and entry of a valid password, which often populates automatically. After connection to the access point 16a, the gateway 20 may be able to “see” the user device 12a but may still block or restrict network access if the MAC address assigned to the user device is not included in the local authorized user list 22. At this point, the administrator may need to obtain the MAC address of the pre-authorization user device to identify the pre-authorization user device on the network.

The NOC 34 facilitates identification of the pre-authorization device 12a on the network without obtaining the complete MAC address from the user by obtaining the computer identification information for all connected users 36. This includes authorized user devices and pre-authorization user devices connected to the network management systems 15a-n supported by the NOC. This typically includes thousands of user devices. The NOC 34 also obtains a system-wide authorized user list 38, which is a combination of the local authorized user list 22 for all of the network management systems 15a-n supported by the NOC. This may also include thousands of user devices. The NOC 34 then determines a pre-authorization user list 40 that includes the computer identification information received from only those user devices that are connected but not authorized to use the network. In other words, the pre-authorization user list 40 identifies those user devices on the connected user list 36 but not on the authorized user list 38. In most cases, the pre-authorization user list 40 is a much smaller list of devices typically including tens as oppose to the thousands of user devices on the connected user list 36 and the authorized user list 38. In the illustrated embodiment, the connected user list 36, the authorized user list 38 and the pre-authorization user list 40 are stored on the gateway 20 and read by the NOC 34 on demand. However, these files may be stored on the NOC 34, the switch or wireless controller 17, one of the access points 16a-n, a cloud storage location, or any other storage location as a matter of design choice. These files may also be assembled on demand, in whole or in part, from data maintained in the access points or other locations. In addition, these files need not be continuously maintained in whole or in part. For example, the data may be acquired only for a particular property, set of properties, or other subset of device on demand on a case-by-case depending on the information available to the administrator in the course of troubleshooting. All or portions of the files may be stored only as deemed appropriate, for example in cache memory, as the need arises. The invention is therefore not limited to any particular storage protocol or location of the for the connected user list 36, the authorized user list 38 and the pre-authorization user list 40.

To further facilitate MAC address identification, the pre-authorization user list 40 may include computer identification information in addition MAC addresses, which may be easier for users to remember or locate. This typically includes the computer names and IP addresses assigned to the pre-authorization user devices as well as the locations and times of failed registration attempts 41. This information is available to the NOC 34 because the gateway 20 collects this information or provides the NOC with access to the access points 16a-n and switch or controller 17, which collect this information from each user device during the access point and/or gateway connection process. The locations and times of failed registration attempts 41 is typically maintained in a computer information systems (CIS) file maintained by the gateway 20, the switch controller 17 or other suitable network component. Conventional gateways and access points have not previously been configured to provide the NOC with access to computer identification information for pre-authorization user devices. Providing the NOC with this access for pre-authorization user devices therefore represents an innovative advancement enabling the NOC to resolve authorization problems more quickly resulting in improved customer service.

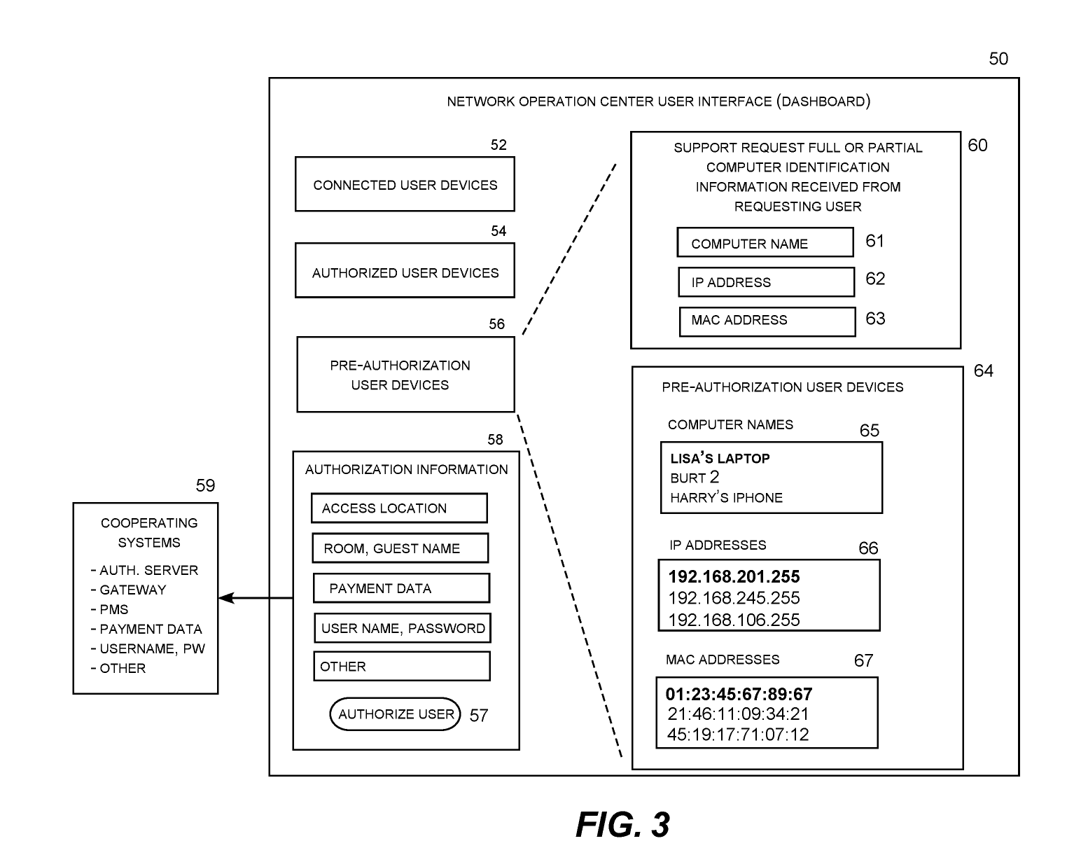

FIG. 3 is a conceptual illustration of a user interface 50 for a network operations center in accordance with an embodiment of the invention. The user interface 50 is a simplified representation of one of many pages displayed by “dashboard” used by the NOC 34 for network administration. The user interface 50 may display a list of the connected user devices 52, a list of the authorized user devices 54, and a list of the pre-authorization user devices 56. Each list typically includes the computer identification information collected for each user device, such as the computer name, IP address and MAC address. The user interface 50 also displays an “authorization information” panel 58 that the administrator uses to enter authorization information collected from a user during a support session to authorize a user device for network access. For example, the authorization information 58 may include the access location (e.g., property or hotspot name) of the user device, room and guest name, payment data, user name and password, or other authorization information. Once the administrator determines that adequate access information has been entered for a pre-authorization user device, the administrator may select the “authorize user” item 57 to complete the authorization. This causes appropriate authorization information to been entered into cooperating systems 59. In general, the NOC 34 may enter into the cooperating systems 59 whatever data the user device 12a would have entered to register without administrator assistance. Referring to FIG. 1, for example, the NOC may enter the MAC address of the pre-authorization user device 12a into the authorization server 24 and/or the local authorized user list 22 at the gateway 20 where the user devices is connected. In a room charge scenario, the NOC 34 enters the room number, guest name and payment authorization information (e.g., days of service, service tier section and payment authorization) into the Property Management System 28. In a financial charge account scenario, the NOC 34 may enter financial payment data (e.g., debit or credit card data) into a payment system. In a prepaid or membership scenario, the NOC 34 may enter club membership data, username and password data, etc. The invention is not limited to any particular type of authorization information or cooperating systems.

To facilitate identification of the pre-authorization user device 12a on the network, the user interface 50 includes an upper panel 60 that includes administrator data entry fields for entering computer identification information received from the user of the pre-authorization user device during a support request. In this example, the computer identification information fields includes a field 61 for entering the computer name, a field 62 for entering the IP address, and a field 63 for entering the MAC address, which allows the administrator to identify the pre-authorization user device using any of these pieces of information. In many cases, a user may recall or know how to look up the computer name or be familiar with the procedure for looking up the IP address more readily than the MAC address. The user interface 50 further facilitates identification of the particular pre-authorization user device associated with the support session by displaying a lower panel 64 containing fields that can scroll through the computer identification information for the user devices connected to the network. The fields of the panel 64 highlight and scroll to the computer identification information records that match the partial computer identification information entered into the panel 60. For example, the “computer names” field 65 highlights and scrolls to detected pre-authorization devices that match a partial or complete computer name entered into the computer name field 61. Similarly, the “IP address” field 66 highlight and scroll to detected pre-authorization devices that match a partial or complete IP address entered into the IP address field 62. And the “MAC address” field 67 highlights and scroll to detected pre-authorization devices that match a partial or complete MAC address entered into the MAC address field 63. This allows the administrator to quickly identify the requesting user's device on the network as soon an adequate amount of any category of computer identification information has been entered into any of the computer identification information fields 61-63.

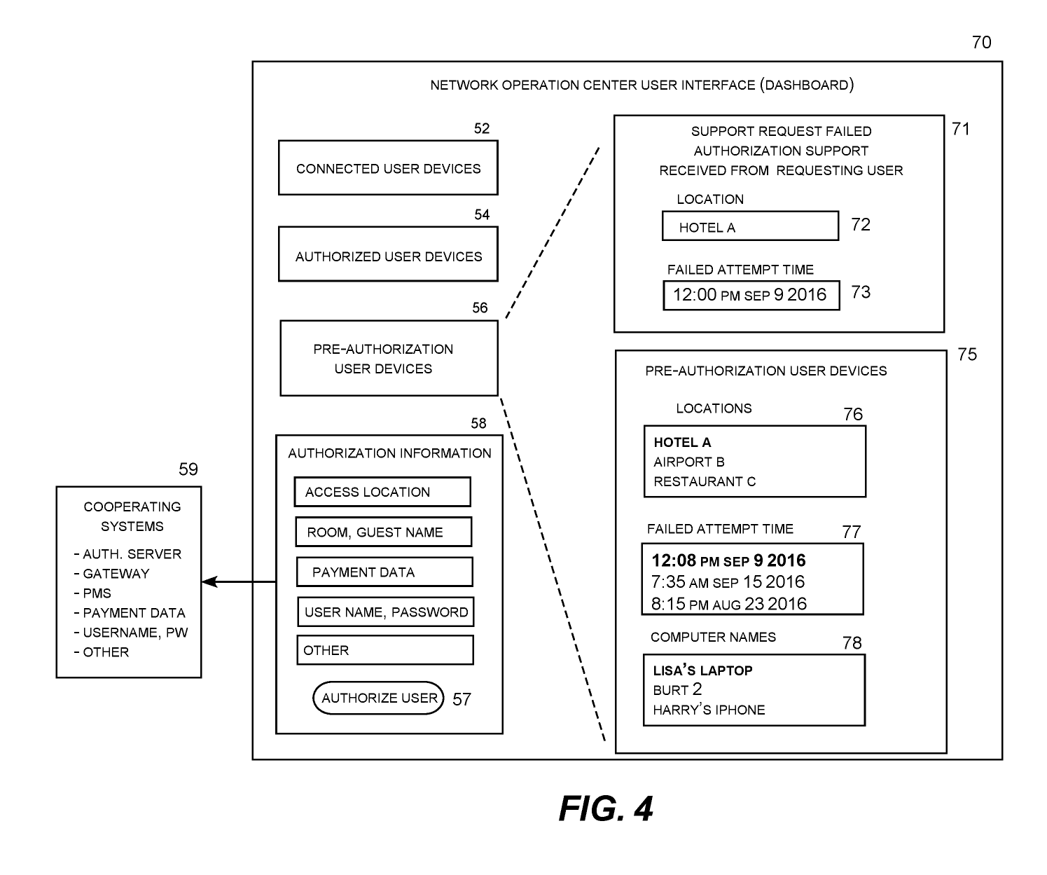

FIG. 4 is a conceptual illustration of an additional user interface 70 for the network operations center in accordance with an embodiment of the invention. The user interface 70 is a simplified representation of another one of many pages displayed by “dashboard” used by the NOC 34 for network administration. The user interface 70 is similar to the user interface 50 except that it displays a different set of computer identification information. The upper panel 71 displays an administrator data entry section that allows the administrator to enter information received from a requesting user into a “location” field 72 and a “failed attempt time” field 73. The “location” field 72 is used to enter the property, such as the hotel, airport, restaurant or other hotspot where the user recently attempted but failed to register for service. The “failed attempt time” field 73 is used to enter the time of the failed registration. Either of these pieces of information greatly reduces the number of pre-authorization devices that might correspond to the requesting user's device, while the combination of both pieces of information will usually reduce the potential matches down to one or a few pre-authorization devices. The lower panel 75 displays and highlights pre-authorization devices connected to the network that match the full or partial computer identification information entered into the fields 72-73 entered by the administrator. These fields include a “locations” field 76, a “failed attempt time” field 77 and a “computer names” field 78. The NOC typically displays the “computer name” as the piece of information that the user is most likely to know from memory or be able to recall if prompted. Additional fields, such as a IP address and MAC address fields, may also be displayed as a matter of design choice.

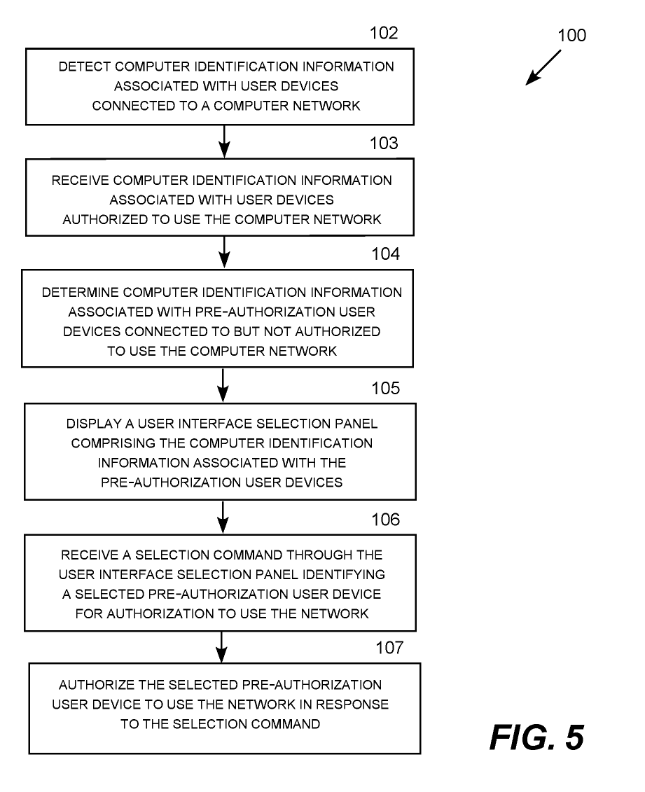

FIG. 5 is a logic flow diagram 100 for operating the NOC 34 in accordance with an embodiment of the invention, which is described with further reference to the representative elements enumerated in FIGS. 1-3. In step 102, the NOC 34 detects computer identification information 36 associated with the user devices 12a-n connected to the network management system 15a, which provides access to the computer network 30. This typically includes collection of computer identification information for large number of user devices connected to large number of access points connected to a large number of network management systems. With respect to the representative user device 12a, this may include interrogating or looking up data stored in the gateway 20, the switch controller 17 and/or the access point 16a, which expose a communication interfaces allowing the NOC 34 to detect the computer identification information for the user device 12a. The gateway 20 and/or the access point 16a collect and expose the computer identification information for the user device 12a regardless of whether the user device is included on the local authorized user list 22 maintained by or in association with the gateway 20. Step 102 is followed by step 103, in which the NOC 34 receives computer identification information 38 associated with user devices authorized to use the computer network 30. This may include interrogating or otherwise obtaining access to the local authorized user list 22 and the list of times and locations of failed registration attempts 41 stored on or in association with the gateway 20. Step 103 is followed by step 104, in which the NOC 34 determines computer identification information 40 associated with pre-authorization user devices connected to, but not authorized to use, the computer network. This may include removing the authorized user devices 38 determined in step 103 from the connected user devices 36 determined in step 102.

Step 104 is followed by step 105, in which the NOC 34 displays a user interface selection panel, such as the panel 50 shown in FIG. 3, comprising the computer identification information 56 associated with the pre-authorization user devices. The NOC 34 may also display the user interface selection panel 70 shown in FIG. 4. The pre-authorization user device list 40 is much shorter than the connected user device list 36 or the connected user device list 38 and thus more easily reviewed by the administrator. This feature alone represents a major improvement over conventional network administration interfaces. The NOC 34 also may display the list of locations and times of failed registration attempts 41, which is another major improvement over conventional network administration interfaces. Step 105 is followed by step 106, in which the NOC 34 receives a selection command through the user interface selection panels 50 and/or 70 identifying a selected pre-authorization user device 12a for authorization to use the network. Selection of the user interface panel 50 invokes the additional user interface panels 60 and 64 to assist the administrator in locating the pre-authorization user device 12a on the network. Similarly, selection of the user interface panel 70 invokes the additional user interface panels 71 and 75 to assist the administrator in locating the pre-authorization user device 12a on the network. Step 106 is followed by step 107, in which the NOC 34 authorizes the selected pre-authorization user device 12a to use the network 30 in response to the selection command. This may include selection of the “authorize user” item 57 shown in FIGS. 3 and 4. The NOC 34 may also receive authorization information from the requesting user and enter that information into the appropriate field(s) of the authorization information panel 58. For example, the authorization information may include a guest name and room number, payment data, a username and password, or other authorization information. Selection of the “authorize user” item 57 cause the NOC 34 to enter the authorization information into cooperating systems 59. For example, the NOC 34 may add the MAC address for the pre-authorization user device 12a into the local authorized user list 22 and submit the guest name, room number and service selection data (e.g., days of service, service tier selection and payment authorization) to the Property Management System 28. In a financial charge account scenario, the NOC may enter financial payment data (e.g., debit or credit card data) into a payment system. In a prepaid or membership scenario, the NOC may enter club membership data, username and password data, etc.

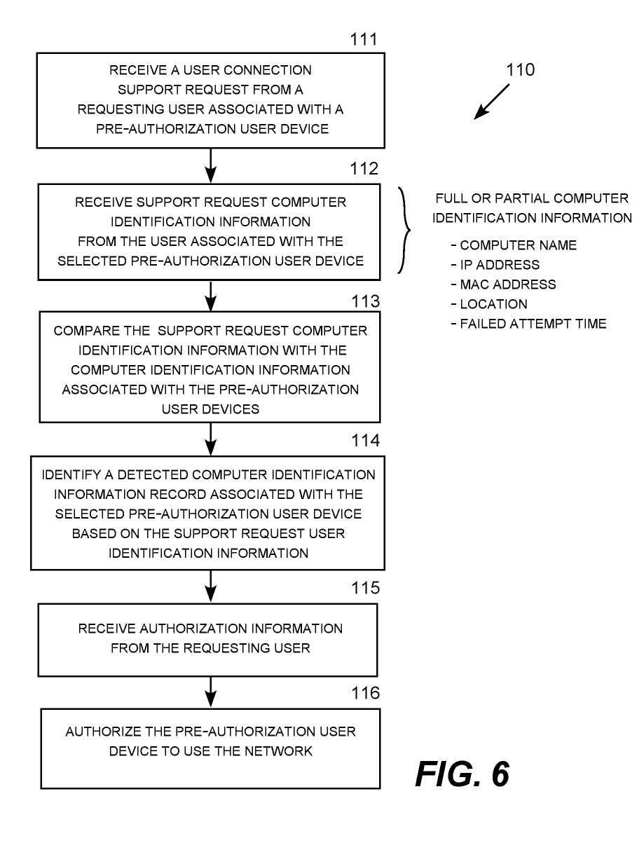

FIG. 6 is an addition logic flow diagram 110 for operating the NOC 34 in accordance with an embodiment of the invention. In step 111, the NOC 34 receives a user connection support request from a requesting user associated with a pre-authorization user device 12a. Step 111 is followed by step 112, in which the NOC 34 receives support request computer identification information from the user associated with the pre-authorization user device 12a. The administrator may enter support request computer identification information received from the user into the appropriate field(s) 61-63 of the support request panel 60 shown in FIG. 3. The administrator may also enter support request computer identification information received from the user into the appropriate field(s) 72 and/or 73 of the support request panel 70 shown in FIG. 4. Step 112 is followed by step 113. If the administrator has selected user interface panel 50, the NOC 34 compares the support request computer identification information in panel 60 with the computer identification information associated with the pre-authorization user devices in panel 64. If the administrator has selected user interface panel 70, the NOC 34 compares the support request computer identification information in panel 71 with the computer identification information associated with the pre-authorization user devices in panel 75.

For the computer identification information in panel 60, the NOC 34 may facilitate identification of the pre-authorization user device 12a on the network by causing the “computer names” field 65 to highlight and scroll to the detected pre-authorization devices that match a partial or complete computer name entered into the computer name field 61. Similarly, the “IP address” field 66 highlights and scrolls to detected pre-authorization devices that match a partial or complete IP address entered into the “IP address” field 62. And the “MAC address” field 67 highlights and scrolls to detected pre-authorization devices that match a partial or complete MAC address entered into the “MAC address” field 63. This allows the administrator to quickly identify the requesting user's device as soon an adequate amount of any category of computer identification information has been entered into any of the computer identification information fields 61-63.

For the computer identification information in panel 70, the NOC 34 may facilitate identification of the pre-authorization user device 12a on the network by causing the “location” field 76, the “failed attempt time” field 77 and the “computer names” field 78 to display and highlight pre-authorization user devices that most closely match the full or partial information entered by the administrator into the “location” field 72 and/or the “failed attempt time” field 73. This allows the administrator to quickly identify the requesting user's device as soon an adequate amount of any category of computer identification information has been entered into any of the computer identification information fields 72-73.

Step 113 is followed by step 114, in which the NOC 34 identifies a detected computer identification information record in the fields 65-67 associated with the selected pre-authorization user device 12a based on the support request user identification information entered into one or more of the fields 61-63 of the support request panel 60. The NOC 34 may also identify a detected computer identification information record in the fields 76-78 associated with the selected pre-authorization user device 12a based on the support request user identification information entered into one or more of the fields 72-73 of the support request panel 70. Step 114 is followed by step 115, in which the NOC 34 may receive authorization information from the requesting user, which the administrator enters into the “authorization information” panel 58. Step 115 is followed by step 116, in which the NOC 34 authorizes the pre-authorization user device 12a to use the network 30 by selecting the “authorize user” item 57, which causes the NOC 34 to enter the authorization information for the user device 12a into cooperating systems 59.

All of the methods described in this disclosure may include storing results of one or more steps of the method embodiments in a non-transient storage medium. The results may include any of the results described in this disclosure and may be stored in any manner known in the art. The storage medium may include any storage medium described in this disclosure or any other suitable storage medium known in the art. After the results have been stored, the results can be accessed in the storage medium and used by any of the method or system embodiments described in this disclosure, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

Those having skill in the art will appreciate that there are various vehicles by which processes and/or systems and/or other technologies described in this disclosure can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described in this disclosure may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth in this disclosure, and then use engineering practices to integrate such described devices and/or processes into data processing systems. That is, at least a portion of the devices and/or processes described can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. All of the technology described in this disclosure is suitable for implementation using commercially available computing devices, such as network servers operated by the situational awareness system and smartphones or personal computers operated by members and customers. These computing devices may be interconnected via the Internet, mobile telephone voice and data system, or other data suitable network..

This disclosure sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components may be combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “functionally connected” to each other to achieve the desired functionality. Specific examples of functional connection include but are not limited to physical connections and/or physically interacting components and/or wirelessly communicating and/or wirelessly interacting components and/or logically interacting and/or logically interacting components.

While particular aspects of the present subject matter have been shown and described in detail, it will be apparent to those skilled in the art that, based upon the teachings of this disclosure, changes and modifications may be made without departing from the subject matter described in this disclosure and its broader aspects and, therefore, the appended claims are to encompass within their scope all such changes and modifications as are within the true spirit and scope of the subject matter described in this disclosure. Although particular embodiments of this disclosure have been illustrated, it is apparent that various modifications and embodiments of the disclosure may be made by those skilled in the art without departing from the scope and spirit of the disclosure. Accordingly, the scope of the disclosure should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The disclosure is defined by the following claims, which should be construed to encompass one or more structures or function of one or more of the illustrative embodiments described above, equivalents and obvious variations.

The invention claimed is:

1. A method for administering access to a computer network, comprising:
detecting computer identification information associated with user devices connected to the computer network;
receiving computer identification information associated with user devices authorized to use the computer network;
determining computer identification information associated with pre-authorization user devices connected to, but not authorized to use, the computer network;
displaying a user-interface selection panel comprising the computer identification information associated with the pre-authorization user devices;
receiving a selection command through the user-interface selection panel identifying a selected pre-authorization user device for authorization to use the network;
authorizing the selected pre-authorization user device to use the network in response to the selection command.

2. The method of claim 1, further comprising:
receiving a user connection support request from a requesting user associated with the selected pre-authorization user device;
receiving support request computer identification information from the requesting user associated with the selected pre-authorization user device;
comparing the support request computer identification information to the computer identification information associated with the pre-authorization user devices;
identifying a detected computer identification information record associated with the selected pre-authorization user device based on the support request user identification information.

3. The method of claim 2, wherein the support request computer identification information comprises a computer name, IP address, MAC address, location, or failed registration attempt time associated with the selected pre-authorization user device.

4. The method of claim 2, wherein the support request computer identification information comprises a partial computer name, IP address, MAC address, location, or failed registration attempt time associated with the selected pre-authorization user device.

5. The method of claim 2, further comprising:
receiving authorization information from the requesting user;
authorizing the pre-authorization user device to use the network based on the detected computer identification information record associated with the pre-authorization user device and the authorization information received from the requesting user.

6. The method of claim 5, wherein the authorization information received from the requesting user is selected from the group consisting of:
a room number and guest name associated with a hotel guest registration;
payment data;
a user name and password associated with the pre-authorization user device;
a user name and password associated with the registering user.

7. A computer storage medium storing non-transitory instructions executable by a computer for causing the computer to administer access to a computer network, comprising:
detecting computer identification information associated with user devices connected to the computer network;
receiving computer identification information associated with user devices authorized to use the computer network;
determining computer identification information associated with pre-authorization user devices connected to, but not authorized to use, the computer network;
displaying a user-interface selection panel comprising the computer identification information associated with the pre-authorization user devices;
receiving a selection command through the user-interface selection panel identifying a selected pre-authorization user device for authorization to use the network;
authorizing the selected pre-authorization user device to use the network in response to the selection command.

8. The computer storage medium of claim 7, further comprising:
receiving a user connection support request from a requesting user associated with the selected pre-authorization user device;
receiving support request computer identification information from the requesting user associated with the selected pre-authorization user device;
comparing the support request computer identification information to the computer identification information associated with the pre-authorization user devices;
identifying a detected computer identification information record associated with the selected pre-authorization user device based on the support request user identification information.

9. The computer storage medium of claim 8, wherein the support request computer identification information comprises a computer name, IP address, MAC address, location, or failed registration attempt time associated with the selected pre-authorization user device.

10. The computer storage medium of claim 8, wherein the support request computer identification information comprises a partial computer name, IP address, MAC address, location, or failed registration attempt time associated with the selected pre-authorization user device.

11. The computer storage medium of claim 8, further comprising:
receiving authorization information from the requesting user;
authorizing the pre-authorization user device to use the network based on the detected computer identification information record associated with the pre-authorization user device and the authorization information received from the requesting user.

12. The computer storage medium of claim 11, wherein the authorization information received from the requesting user is selected from the group consisting of:
a room number and guest name associated with a hotel guest registration;
payment data;
a user name and password associated with the pre-authorization user device;
a user name and password associated with the registering user.

13. A system for computer network administration, comprising:
a plurality of access points, each configured to connect a plurality of user devices to a computer network;
a plurality of gateways, each configured to connect a plurality of the access points to the network and to provide interrogation access to the computer identification information associated with the user devices connected to the gateway or to the access points connected to the gateway;
a network operations center configured for:
detecting computer identification information associated with user devices connected to the computer network,
receiving computer identification information associated with user devices authorized to use the computer network,
determining computer identification information associated with pre-authorization user devices connected to, but not authorized to use, the computer network,
displaying a user-interface selection panel comprising the computer identification information associated with the pre-authorization user devices,
receiving a selection command through the user-interface selection panel identifying a selected pre-authorization user device for authorization to use the network,
authorizing the selected pre-authorization user device to use the network in response to the selection command.

14. The system of claim 13, wherein the network operations center is further configured for:
receiving a user connection support request from a requesting user associated with the selected pre-authorization user device;
receiving support request computer identification information from the requesting user associated with the selected pre-authorization user device;
comparing the support request computer identification information to the computer identification information associated with the pre-authorization user devices;
identifying a detected computer identification information record associated with the selected pre-authorization user device based on the support request user identification information.

15. The system of claim 14, wherein the support request computer identification information comprises a computer name, IP address, MAC address, location, or failed registration attempt time associated with the selected pre-authorization user device.

16. The system of claim 14, wherein the support request computer identification information comprises a partial computer name, IP address, MAC address, location, or failed registration attempt time associated with the selected pre-authorization user device.

17. The system of claim 14, wherein the network operations center is further configured for:
receiving authorization information from the requesting user;
authorizing the pre-authorization user device to use the network based on the detected computer identification information record associated with the pre-authorization user device and the authorization information received from the requesting user.

18. The system of claim 17, wherein the authorization information received from the requesting user is selected from the group consisting of:
a room number and guest name associated with a hotel guest registration;
payment data;
a user name and password associated with the pre-authorization user device;
a user name and password associated with the registering user.

19. A network operations center, comprising:
means for detecting computer identification information associated with user devices connected to the computer network;
means for receiving computer identification information associated with user devices authorized to use the computer network;
means for determining computer identification information associated with pre-authorization user devices connected to, but not authorized to use, the computer network;
means for displaying a user-interface selection panel comprising the computer identification information associated with the pre-authorization user devices;
means for receiving a selection command through the user-interface selection panel identifying a selected pre-authorization user device for authorization to use the network;
means for authorizing the selected pre-authorization user device to use the network in response to the selection command.

20. The network operations center of claim 19, further comprising:
means for receiving a user connection support request from a requesting user associated with the selected pre-authorization user device;
means for receiving support request computer identification information from the requesting user associated with the selected pre-authorization user device;
means for comparing the support request computer identification information to the computer identification information associated with the pre-authorization user devices;
means for identifying a detected computer identification information record associated with the selected pre-authorization user device based on the support request user identification information.

21. The network operations center of claim 20, wherein the support request computer identification information comprises a computer name, IP address, MAC address, location, or failed registration attempt time associated with the selected pre-authorization user device.

22. The network operations center of claim 20, wherein the support request computer identification information comprises a partial computer name, IP address, MAC address, location, or failed registration attempt time associated with the selected pre-authorization user device.

23. The network operations center of claim 20, further comprising:
means for receiving authorization information from the requesting user;
means for authorizing the pre-authorization user device to use the network based on the detected computer identification information record associated with the pre-authorization user device and the authorization information received from the requesting user.

24. The network operations center of claim 23, wherein the authorization information received from the requesting user is selected from the group consisting of:
a room number and guest name associated with a hotel guest registration;
payment data;
a user name and password associated with the pre-authorization user device;
a user name and password associated with the registering user.
